(19) United States
(12) Patent Application Publication
(10) Pub. No.: US 2006/0254245 A1
(43) Pub. Date: Nov. 16, 2006

(54) Putting green rake

(76) Inventor: Henry Hernandez, New Berlin, WI (US)

Correspondence Address: RYAN KROMHOLZ & MANION, S.C., POST OFFICE BOX 26618, MILWAUKEE, WI, 53226, US

(21) Appl. No.: 11/397,498

(22) Filed: Apr. 4, 2006

Related U.S. Application Data
(60) Provisional application No. 60/668,190, filed on Apr. 4, 2005.

(51) Int. Cl. A01D 7/00

(52) U.S. Cl. 56/400.19

(57) ABSTRACT

The present invention is for a rake designed for removing debris from putting greens, fairways, and similar surfaces.

### RELATED APPLICATION

This application claims the benefit of U.S. Provisional Patent Application Ser. No. 60/668,190, filed 4 Apr. 2005, and entitled “Putting Green Rake.”

### BACKGROUND OF THE INVENTION

The present invention pertains to golf related devices and, more particularly, to golf rakes and similar devices for clearing putting surfaces and the like.

On many golf courses, especially in the spring and fall, leaves, sticks, and similar debris can cover a putting green. It is not always possible for the groundskeeper to remove all of these objects before a person plays a hole, especially in wooded or forest areas where leaves may consistently fall onto the green. Thus, if a person wishes to have a clean lie before putting, leaves, sticks, and other similar objects need to be removed before putting, which can be an arduous, time-consuming undertaking.

Likewise, when removing leaves from a green, a person must be careful to not damage a green when removing the debris. That is, any devices or tools used to remove leaves preferably would not have sharp points that could cause divots or the like in the putting surface.

Even more of a nuisance than leaves on the green is droppings from animals. Often times, geese, ducks, and other similar birds tend to congregate around golf courses, especially courses that have water hazards located on the course. Consequently, the birds' droppings and refuse cover the fairways and greens. People generally do not want to touch the refuse, or move it away with a golf club, either.

Rakes have been designed for cleaning and smoothing sand traps and bunkers and performing general maintenance on golf courses. However, these rakes are generally heavy and should not be used on putting greens, since they may damage the greens and are not necessarily designed for only removing debris from the surface that is being raked.

Leaf blowers, vacuums and similar devices are known for removing leaves from a lawn or other grassy surface. While these devices are suitable for a groundskeeper, they would not be realistic for an individual to carry around from green to green when playing a round of golf, and they are not practical for removing bird waste. Likewise, it would not be practical to have such a device located at each green of a golf course, as it would not be economical, both in the number of devices required and the extra upkeep required in leaving the devices outside for extended periods of times. They are also not generally good for removing bird waste.

It would be desirous to have a rake or similar device for removing debris from a putting green or surface that is easy to use, move, and transport. Further, it is desirous to have a device that can remove debris from a green in such a manner not to cause damage to the green itself.

### SUMMARY OF THE INVENTION

The present invention is for a rake designed for use on putting greens and similar surfaces. The rake is designed so that an individual may easily transport the rake, preferably within the individual's golf bag.

The rake will be similar in shape to a golf club, having a shaft with a grip on one end and a rake-like surface on the opposite end. The teeth of the rake-like surface are arranged substantially adjacent to one another to gather leaves and other debris on the putting green, while not damaging the golf green itself.

### BRIEF DESCRIPTION OF THE DRAWINGS

FIG. 1 is a perspective view of a device according to the present invention.

FIG. 2 is a front elevated view of the device of FIG. 1.

FIG. 3 is a side elevated view of the device of FIG. 1.

FIG. 4 is a perspective view of the device according to the present invention stored within a golf bag.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

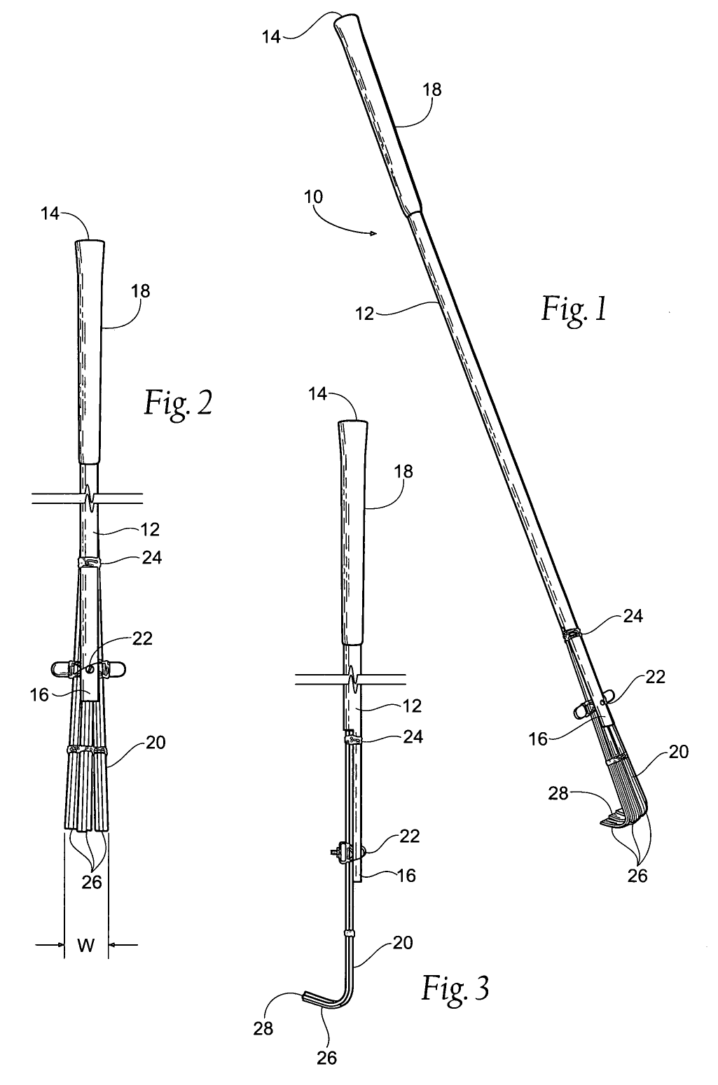

FIGS. 1-3 provide various views of a raking device 10 according to the present invention. The device 10 comprises a shaft 12 that has a first end 14 and a second end 16. The shaft 12 may be of any length desired, and may be of an extendable or retractable design. The first end 12 further comprises a gripping surface 18, which allows the user to easily grab and use the device 10. Preferably, the gripping surface 18 is the same or similar to grips or gripping surfaces used on golf clubs. The second end 16 of the shaft 12 is connected to a rake 20 by connection means 22 and 24. The term rake 20 should be used broadly to include any shape, design or area where the shaft 12 terminates. As shown, the connection means 22 comprises a nut and bolt and the connection means 24 comprises an elastic-style string that is wrapped and further glued around the rake 20 and the shaft 12 to secure and connect the two sections together. However, it is understood that any means that would secure the rake 20 to the shaft 12 would fall within the scope of the present invention. Likewise, more or fewer connection means than shown could be used for the device 10, and the rake 20 and shaft 12 could be unitary and integral with one another.

The rake 20 has a plurality of tines 26 extending from the rake 20. The tines 26 are arranged sufficiently close together and substantially adjacent to one another, thereby providing a tine structure that will properly gather leaves or other debris off of a putting surface, while not damaging the putting surface. The tines 26 are not necessarily designed for grabbing leaves with the tines as typical lawn rakes are designed, but are designed to act as more of a pulling or sweeping device over the golf surface. The tines 26 are arranged differently from previous rakes used for sand traps or bunkers, and rakes in general. The present arrangement of the tines is specifically designed for use on fairways and greens, as opposed to sand traps or bunkers. Likewise, because the device 10 is not designed as a gardening rake, the tines 26 are arranged to work along the surface, rather than digging into the surface. Also, the ends 28 of the tines 26 are preferably blunt, which will further insure the device 10 does not damage the putting surface. Prior art rakes, such as sand trap rakes or gardening rakes could not be used in place of the present invention, since such use would lead to potential damage of the surface of the green or fairway. Though any material may be used to design the rake 20, a lightweight material, such as wood or bamboo, is preferred to insure damage is not done to the putting surface.

The shaft 12 may be of any length or dimension as desired. However, it is preferable to have the shaft 12 be of the same dimensions as an ordinary golf club shaft. Thus, when the user carrying the device within his or her golf bag, it will look like another golf club and be aesthetically pleasing. The shaft may also be of any material, but preferably of a lightweight material, similar to the material used for the rake 12.

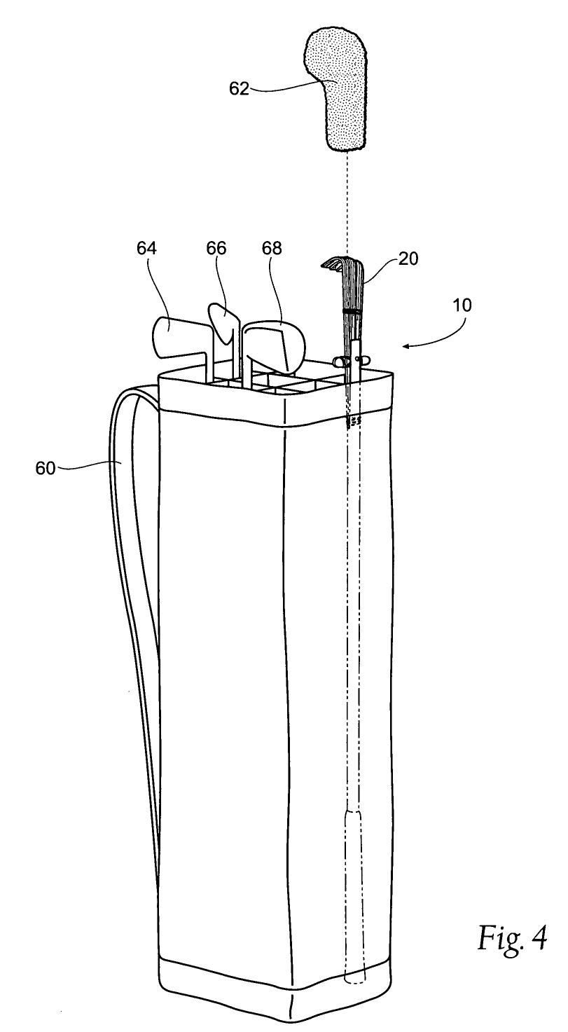

As with the shaft 12, the rake 20 may be of any dimensions. However, it is preferable to have the rake 20 relatively the same size as a normal golf club head, which will further ease carrying the device 10 in a golf bag 60. That is, the overall or total width W of the tines 26 will be relatively the size of typical golf club head or less. While the width W may be larger, it is preferable to have the width generally the size of a golf club head or less so that the device 10 is easy to carry in a golf bag. For instance, most golf club heads (woods) have a width generally less than about 5 inches, with irons having smaller widths. It is preferred to for the width of the present device to be in a similar dimensional range. To further make the device 10 aesthetically appealing when carrying the device 10 in the golf bag 60, a cover 62, similar to a golf club cover, may be used to cover the rake 20 portion of the device 10. As FIG. 4 shows, the rake 20 sits within the golf bag 60 without interfering with other possible clubs 64, 66, 68, in the bag. Thus, the rake 20 will be easily transported and accessible whenever desired. The ease and ability of the device 10 to be easily transported in a golf bag 60 without interfering with other golf clubs in the golf bag also is an advantage over prior art rakes and similar devices. Typical golf rakes and garden rakes could not be transported in a golf bag without the head of the rake interfering with use of the other clubs or potentially injuring the person carrying the bag, or both.

Furthermore, the design of the rake 20 portion of the device as being relatively the same size as a typical golf club head not only enhances the novelty for the device 10 to be transported in a golf bag, but also such dimensions had not previously been contemplated in the prior art. The dimensional elements of the present invention is not obvious when compared to the prior art, because prior art rakes were designed for raking a large portion of a lawn or other similar surface in as quick a time as possible. Prior art rakes were designed with as large a tine area as possible to remove as much leaves or debris as possible, which would teach away from the dimensions and uses of the present invention. Likewise, because rakes have been designed to grab and collect leaves as efficiently as possible, the tines of the rakes were spaced apart so that leaves would become trapped between the tines. However, these rakes were not designed to work upon a surface, such as a green or putting surface, so that the surface was substantially untouched, and the arrangement of the tines also is not obvious or taught in the prior art. Thus, the present invention has several unique features that are not present in the prior art.

The device 10 will improve the condition of a golf green and/or fairway by removing unnecessary debris in a quick and efficient way. Because the user is only concerned about a small, specific area where the user may be hitting or putting, the device directly addresses thes needs. Further, because there have not been other known devices that can easily remove bird droppings from the golfing surfaces, the present invention provides a novel device that will allow a person to keep one's hands, shoes, and clubs clean when the person is trying to remove refuse or debris from the golfing surface. The device 10 can be used on any golf surface, such as a green, putting green, fairway, tee box, or other similar mowed area or field easily and efficiently.

The foregoing is considered as illustrative only of the principles of the invention. Furthermore, since numerous modifications and changes will readily occur to those skilled in the art, it is not desired to limit the invention to the exact construction and operation shown and described.

I claim:

1. A device for use on a golf green or fairway for removing debris from said golf green or fairway, said device comprising:
a shaft;
a rake connected to said shaft; and
at least one tine located on said rake, said at least one tine being arranged to remove debris from said golf green or fairway without damaging said golf green or fairway.

2. The device according to claim 1 further comprising a plurality of tines, said tines being arranged substantially adjacent to one another.

3. The device according to claim 2 wherein said plurality of tines comprises a width generally the width of a typical golf club head or less.
